(19) United States
(12) Patent Application Publication
(10) Pub. No.: US 2024/0229272 A9
(43) Pub. Date: Jul. 11, 2024

(54) FUEL CELL SYSTEM WITH EXHAUST GAS CONCENTRATION MONITORING

(71) Applicant: FuelCell Energy, Inc., Danbury, CT (US)

(72) Inventor: Jonathan MALWITZ, Danbury, CT (US)

(21) Appl. No.: 18/489,928

(22) Filed: Oct. 19, 2023

Related U.S. Application Data
(60) Provisional application No. 63/418,100, filed on Oct. 21, 2022.

(51) Int. Cl. C25B 15/029; C25B 1/04

(52) U.S. Cl. CPC C25B 15/029; C25B 1/04; H01M 8/04462

(57) ABSTRACT

An electrolysis cell system includes a cathode portion configured to output a cathode exhaust stream, an anode portion configured to output an anode exhaust stream, a sensor configured to detect a concentration in an exhaust stream and to output sensor data, wherein the sensor is either a hydrogen concentration sensor configured to detect a hydrogen concentration in the cathode exhaust stream or a water concentration sensor configured to detect a water concentration of the anode exhaust stream, and a controller. The controller is configured to receive the sensor data from the sensor and, based on the sensor data, control at least one of (a) an air pressure adjustment device to adjust a pressure of air entering the anode portion or (b) a steam pressure adjustment device to adjust a pressure of steam entering the cathode portion.

### CROSS-REFERENCE TO RELATED PATENT APPLICATION

This application claims the benefit of and priority to U.S. Provisional Application No. 63/418,100, filed on Oct. 21, 2022, which is incorporated by reference herein in its entirety.

### BACKGROUND

The present disclosure relates generally to the field of electrochemical cells, such as fuel cells and electrolysis cells, and more particularly to pressure control of fuel cell inputs.

Generally, a fuel cell is a type of electrochemical cell that includes an anode, a cathode, and an electrolyte layer that together drive chemical reactions to produce electricity. Multiple fuel cells may be arranged in a stack to produce a desired amount of electricity. Fuel gas, such as hydrogen gas or hydrocarbon gas, is supplied to the anode, while oxidant gas is supplied to the cathode. The fuel gas and oxidant gas are used up by the electrochemical reactions as they flow over the anode and cathode, respectively.

A fuel cell may be operated in reverse as an electrolysis cell. In an electrolysis mode, an external power source provides an electric current to the cell, and water is supplied to the cathode as steam. Oxygen ions from the water molecules cross over the electrolyte to the anode while the hydrogen remains in the cathode. Thus, water molecules may be split into hydrogen gas and oxygen gas.

A difference in pressure between the reactants in the anode and cathode can cause the reactant gases to cross the electrolyte layer to the opposite electrode, a phenomenon called crossover. Crossover can result in reduced performance and efficiency, as the reactants that cross the electrolyte are not able to be utilized in the chemical reactions that generate electricity. Further, excessive differential pressure between the anode and cathode can impart stresses into the electrochemical cells.

### SUMMARY

Systems and methods of the present disclosure relate to the monitoring of water and hydrogen concentration in fuel cell systems and electrolysis systems to monitor crossover of reactant gases. Reactant gas pressures can be adjusted to reduce or otherwise adjust the amount of crossover.

One embodiment relates to an electrolysis cell system including a cathode portion configured to output a cathode exhaust stream, an anode portion configured to output an anode exhaust stream, and a sensor configured to detect a concentration in an exhaust stream and to output sensor data. The sensor is either a hydrogen concentration sensor configured to detect a hydrogen concentration in the cathode exhaust stream or a water concentration sensor configured to detect a water concentration of the anode exhaust stream. The electrolysis cell system further includes a controller configured to receive the sensor data from the sensor and, based on the sensor data, control at least one of (a) an air pressure adjustment device to adjust a pressure of air entering the anode portion or (b) a steam pressure adjustment device to adjust a pressure of steam entering the cathode portion.

In one aspect, which is combinable with any other aspects or embodiments, the electrolysis cell system further includes a first pressure transducer configured to measure anode gas pressure in the anode portion and a second pressure transducer configured to measure cathode gas pressure in the cathode portion, wherein at least one of the air pressure adjustment device or the steam pressure adjustment device is controlled in part based on a comparison between the measured anode gas pressure and the measured cathode gas pressure.

In one aspect of the electrolysis cell system, which is combinable with any other aspects or embodiments, the controller is further configured to determine a differential pressure between the cathode portion and the anode portion based on the comparison between the measured anode gas pressure and the measured cathode gas pressure and the sensor data.

In one aspect of the electrolysis cell system, which is combinable with any other aspects or embodiments, the air pressure adjustment device is a back-pressure regulator configured to allow the anode exhaust stream to flow therethrough and the steam pressure adjustment device is a back-pressure regulator configured to allow the cathode exhaust stream to flow therethrough.

In one aspect of the electrolysis cell system, which is combinable with any other aspects or embodiments, the sensor is a hydrogen concentration sensor and the controller is configured to at least one of (a) control the steam pressure adjustment device to increase the pressure of steam entering the cathode portion when the sensor data indicates a decrease in the hydrogen concentration of the cathode exhaust steam or (b) control the air pressure adjustment device to decrease the pressure of air entering the anode portion when the sensor data indicates a decrease in the hydrogen concentration of cathode exhaust stream.

In one aspect of the electrolysis cell system, which is combinable with any other aspects or embodiments, the sensor is a water concentration sensor and the controller is configured to at least one of (a) control the steam pressure adjustment device to decrease the pressure of steam entering the cathode portion when the sensor data indicates an increase in the water concentration of anode exhaust stream or (b) control the air pressure adjustment device to increase the pressure of air entering the anode portion when the sensor data indicates an increase in the water concentration of anode exhaust stream.

Another embodiment relates to an electrolysis cell system including a cathode portion configured to output a cathode exhaust stream, an anode portion configured to output an anode exhaust stream, a first hydrogen concentration sensor configured to detect a hydrogen concentration in the cathode exhaust stream, a controller. The controller is configured to receive first hydrogen concentration sensor data from the first hydrogen concentration sensor and, based on the first hydrogen concentration sensor data, control at least one of (a) an air pressure adjustment device to adjust a pressure of air entering the anode portion or (b) a steam pressure adjustment device to adjust a pressure of steam entering the cathode portion.

In one aspect of the electrolysis cell system, which is combinable with any other aspects or embodiments, the controller is configured to, when the first hydrogen concentration sensor data indicates that the hydrogen concentration in the cathode exhaust stream has decreased below a predetermined threshold, control at least one of (a) the steam pressure adjustment device to increase the pressure of steam entering the cathode portion or (b) the air pressure adjustment device to decrease the pressure of air entering the anode portion.

In one aspect, which is combinable with any other aspects or embodiments, the electrolysis cell system further includes a second hydrogen concentration sensor configured to detect a hydrogen concentration of a cathode input stream, the cathode portion configured to receive the cathode input stream, and the controller is further configured to receive second hydrogen concentration sensor data from the second hydrogen concentration sensor, compare the first hydrogen concentration sensor data to the second hydrogen concentration sensor data, and control at least one of the air pressure adjustment device or the steam pressure adjustment device based on the comparison.

In one aspect, which is combinable with any other aspects or embodiments, the electrolysis cell system further includes a first pressure transducer configured to measure anode gas pressure in the anode portion and a second pressure transducer configured to measure cathode gas pressure in the cathode portion, wherein at least one of the air pressure adjustment device or the steam pressure adjustment device is controlled in part based on a comparison between the measured anode gas pressure and the measured cathode gas pressure.

In one aspect, which is combinable with any other aspects or embodiments, the electrolysis cell system further includes a first water concentration sensor configured to detect a water concentration of the anode exhaust stream, wherein the controller is configured to receive first water concentration sensor data from the first water concentration sensor, and based on both the first water concentration sensor data and the first hydrogen concentration sensor data, control at least one of (a) the air pressure adjustment device to adjust the pressure of air entering the anode portion or (b) the steam pressure adjustment device to adjust the pressure of steam entering the cathode.

In one aspect of the electrolysis cell system, which is combinable with any other aspects or embodiments, the controller is configured to, when the water concentration sensor data indicates that the water concentration in the anode exhaust stream has increased beyond a predetermined threshold, control at least one of (a) the air pressure adjustment device to increase the pressure of air entering the anode portion or
(b) the steam pressure adjustment device to decrease the pressure of steam entering the cathode portion.

In one aspect, which is combinable with any other aspects or embodiments, the electrolysis cell system further includes a second hydrogen concentration sensor configured to detect a hydrogen concentration of a cathode input stream and a second water concentration sensor configured to detect a water concentration of an anode input stream, the cathode portion configured to receive the cathode input stream.

In one aspect of the electrolysis cell system, which is combinable with any other aspects or embodiments, the controller is further configured to receive second hydrogen concentration sensor data from the second hydrogen concentration sensor, receive second water concentration sensor data from the second water concentration sensor, perform a first comparison between the first hydrogen concentration sensor data and the second hydrogen concentration sensor data, perform a second comparison between the first water concentration sensor data and the second water concentration sensor data, and control at least one of the air pressure adjustment device or the steam pressure adjustment device based on the first comparison and the second comparison.

In one aspect of the electrolysis cell system, which is combinable with any other aspects or embodiments, the air pressure adjustment device is a back-pressure regulator configured to allow the anode exhaust stream to flow therethrough and the steam pressure adjustment device is a back-pressure regulator configured to allow the cathode exhaust stream to flow therethrough.

Another embodiment relates to an electrolysis cell system including a cathode portion configured to output a cathode exhaust stream, an anode portion configured to output an anode exhaust stream, a first water concentration sensor configured to detect a water concentration of the anode exhaust stream, and a controller. The controller is configured to receive first water concentration sensor data from the first water concentration sensor and, based on the first water concentration sensor data, control at least one of (a) an air pressure adjustment device to adjust a pressure of air entering the anode portion or (b) a steam pressure adjustment device to adjust a pressure of steam entering the cathode portion.

In one aspect of the electrolysis cell system, which is combinable with any other aspects or embodiments, the controller is configured to, when the first water concentration sensor data indicates that the water concentration of the anode exhaust stream has increased beyond a predetermined threshold, control at least one of (a) the steam pressure adjustment device to decrease the pressure of steam entering the cathode portion or (b) the air pressure adjustment device to increase the pressure of air entering the anode portion.

In one aspect, which is combinable with any other aspects or embodiments, the electrolysis cell system further includes a second water concentration sensor configured to detect a water concentration of an anode input stream, the anode portion configured to receive the anode input stream. The controller is further configured to receive second water concentration sensor data from the second water concentration sensor, compare the first water concentration sensor data to the second water concentration sensor data, and control at least one of the air pressure adjustment device or the steam pressure adjustment device based on the comparison.

In one aspect, which is combinable with any other aspects or embodiments, the electrolysis cell system further includes a first pressure transducer configured to measure a pressure of anode gas in the anode portion and a second pressure transducer configured to measure a pressure of cathode gas in the cathode portion, wherein at least one of the air pressure adjustment device or the steam pressure adjustment device are controlled in part based on the measured anode gas pressure and the measured cathode gas pressure.

In one aspect of the electrolysis cell system, which is combinable with any other aspects or embodiments, the air pressure adjustment device is a back-pressure regulator configured to allow the anode exhaust stream to flow therethrough and the steam pressure adjustment device is a back-pressure regulator configured to allow the cathode exhaust stream to flow therethrough.

Another embodiment relates to a fuel cell system including a cathode portion configured to output a cathode exhaust stream, an anode portion configured to output an anode exhaust stream, a water concentration sensor configured to detect a water concentration of the cathode exhaust stream, and a controller. The controller is configured to receive water concentration sensor data from the water concentration sensor and, based on the water concentration sensor data, control at least one of (a) an oxidant gas pressure adjustment device to adjust a pressure of oxidant gas entering the cathode portion or (b) a fuel gas pressure adjustment device to adjust a pressure of fuel gas entering the anode portion.

In one aspect of the fuel cell system, which is combinable with any other aspects or embodiments, the controller is configured to, when the water concentration sensor data indicates that the water concentration of the cathode exhaust stream has increased beyond a predetermined threshold, control at least one of (a) the oxidant gas pressure adjustment device to increase the pressure of oxidant gas entering the cathode portion or (b) the fuel gas pressure adjustment device to decrease the pressure of fuel gas entering the anode portion.

In one aspect of the fuel cell system, which is combinable with any other aspects or embodiments, the cathode portion is configured to receive a cathode input stream, and the system further includes a second water concentration sensor configured to detect a water concentration of the cathode input stream. The controller is further configured to receive second water concentration sensor data from the second water concentration sensor compare the water concentration sensor data to the second water concentration sensor data, and control at least one of the oxidant gas pressure adjustment device or the fuel gas pressure adjustment device based on the comparison.

In one aspect, which is combinable with any other aspects or embodiments, the fuel cell system further includes a first pressure transducer configured to measure anode gas pressure in the anode portion and a second pressure transducer configured to measure cathode gas pressure in the cathode portion, wherein at least one of the oxidant gas pressure adjustment device or the fuel gas pressure adjustment device is controlled in part based on the measured anode gas pressure and the measured cathode gas pressure.

In one aspect, which is combinable with any other aspects or embodiments, the fuel cell system further includes a hydrogen concentration sensor configured to detect a hydrogen concentration of the anode exhaust stream The controller is configured to receive hydrogen concentration sensor data from the hydrogen concentration sensor, and based on both the water concentration sensor data and the hydrogen concentration sensor data, control at least one of the oxidant gas pressure adjustment device to adjust one or more of the pressure of oxidant gas entering the cathode portion or the fuel gas pressure adjustment device to adjust the pressure of fuel gas entering the anode portion.

In one aspect of the fuel cell system, which is combinable with any other aspects or embodiments, the controller is configured to, when the hydrogen concentration sensor data indicates that the hydrogen concentration of the anode exhaust stream has decreased below a predetermined threshold, control at least one of (a) the oxidant gas pressure adjustment device to decrease the pressure of oxidant gas entering the cathode portion or (b) the fuel gas pressure adjustment device to increase the pressure of fuel gas entering the anode portion.

Another embodiment relates to a fuel cell system including a cathode portion configured to output a cathode exhaust stream, an anode portion configured to output an anode exhaust stream, a hydrogen concentration sensor configured to detect a hydrogen concentration of the anode exhaust stream, and a controller. The controller is configured to receive hydrogen concentration sensor data from the hydrogen concentration sensor, and, based on the hydrogen concentration sensor data, control at least one of an oxidant gas pressure adjustment device to adjust a pressure of oxidant gas entering the cathode portion or a fuel gas pressure adjustment device to adjust a pressure of fuel gas entering the anode portion.

In one aspect of the fuel cell system, which is combinable with any other aspects or embodiments, the controller is configured to, when the hydrogen concentration sensor data indicates that the hydrogen concentration of the anode exhaust stream has decreased below a predetermined threshold, control at least one of (a) the oxidant gas pressure adjustment device to decrease the pressure of oxidant gas entering the cathode portion or (b) the fuel gas pressure adjustment device to increase the pressure of fuel gas entering the anode portion.

In one aspect, which is combinable with any other aspects or embodiments, the fuel cell system further includes a second hydrogen concentration sensor configured to detect a hydrogen concentration of an anode input stream, the anode portion configured to receive the anode input stream. The controller is further configured to receive second hydrogen concentration sensor data from the second hydrogen concentration sensor, compare the hydrogen concentration sensor data to the second hydrogen concentration sensor data, and control at least one of the oxidant gas pressure adjustment device or the fuel gas pressure adjustment device based on the comparison.

In one aspect, which is combinable with any other aspects or embodiments, the fuel cell system further includes a first pressure transducer configured to measure anode gas pressure in the anode portion and a second pressure transducer configured to measure cathode gas pressure in the cathode portion, wherein the oxidant gas pressure adjustment device and/or the fuel gas pressure adjustment device are controlled in part based on the measured anode gas pressure and the measured cathode gas pressure.

It will be appreciated that these and other aspects and/or features may be used in any combination.

### BRIEF DESCRIPTION OF THE DRAWINGS

FIG. 1 is a schematic diagram of a fuel cell system, according to an exemplary embodiment.

FIG. 2 is a flow diagram of a method of controlling the pressures of reactants in a fuel cell system, according to an exemplary embodiment.

FIG. 3 is a schematic diagram of an electrolysis cell system, according to an exemplary embodiment.

FIG. 4 is a flow diagram of a method of controlling the pressures of gases in an electrolysis cell system, according to an exemplary embodiment.

It will be recognized that the Figures are schematic representations for purposes of illustration. The Figures are provided for the purpose of illustrating one or more implementations with the explicit understanding that the Figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

In fuel cell systems, a fuel gas stream comprising hydrogen is supplied to the anode of each fuel cell, and an oxidant gas stream comprising air is supplied to the cathode of each fuel cell. If the pressure in the cathode exceeds the pressure in the anode, nitrogen and other gases in the oxidant gas stream may cross over the electrolyte into the anode by diffusing through the electrolyte, passing through small cracks that form in the electrolyte over time. Similarly, if the pressure in the anode exceeds the pressure in the cathode, hydrogen may cross over the electrolyte into the cathode. The hydrogen that crosses over may react with the oxygen in the cathode to form water (e.g., steam). Accordingly, a method of monitoring this crossover so that the input pressures of the fuel gas and oxidant gas can be adjusted and balanced is desirable.

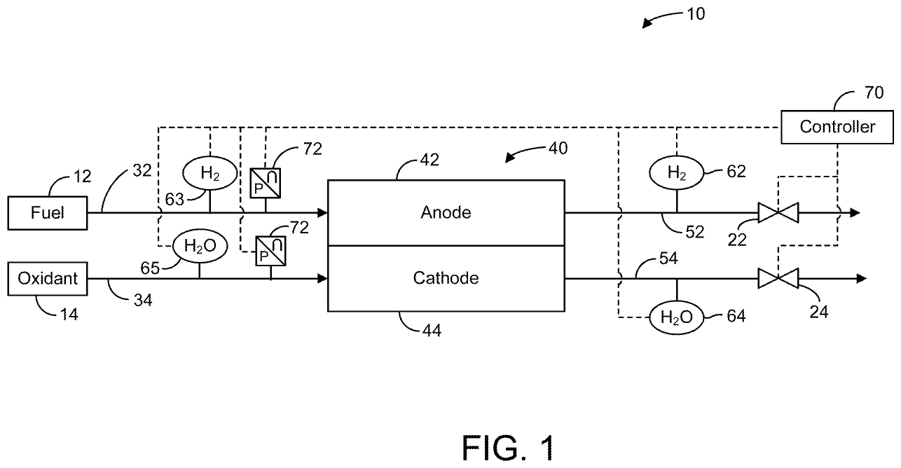

Referring to FIG. 1, a fuel cell system 10 according to an exemplary embodiment is shown. A fuel cell module 40 may include one or more fuel cells arranged in one or more fuel cell stacks. The fuel cell module 40 includes an anode portion 42 and a cathode portion 44. Each fuel cell in the module 40 includes an electrolyte sandwiched between an anode and a cathode. The fuel cells may be, for example, solid oxide fuel cells or molten carbonate fuel cells. Fuel gas, such as hydrogen gas or hydrocarbon fuel gas, is supplied from a fuel gas supply 12 to the anode portion 42 via anode input stream 32 and distributed to the anodes of the fuel cells. Fuel gas back-pressure regulator 22 controls the pressure in the anode portion 42 by controlling the pressure required for fuel gas to flow therethrough. For example, the fuel gas back-pressure regulator 22 may include a spring that holds a valve closed, and fuel gas may only be able to pass through the valve when the pressure in the anode portion 42 overcomes the spring force. The pressure in the anode portion 42 can be increased or reduced by adjusting the spring such that more or less pressure is required to overcome the spring force. In some embodiments, other types of back-pressure regulators, flow regulators, compressors, blowers, or valve assemblies may be used to adjust the pressure in the anode portion 42.

Oxidant gas is supplied from an oxidant gas supply 14 to the cathode portion 44 via cathode input stream 34 and distributed to the cathodes of the fuel cells. Oxidant gas back-pressure regulator 24 controls the pressure in the cathode portion 44 by controlling the pressure required for oxidant gas to flow therethrough. For example, the oxidant gas back-pressure regulator 24 may include a spring that holds a valve closed, and oxidant gas may only be able to pass through the valve when the pressure in the cathode portion 44 overcomes the spring force. The pressure in the cathode portion 44 can be increased or reduced by adjusting the spring such that more or less pressure is required to overcome the spring force. In some embodiments, other types of back-pressure regulators, flow regulators, compressors, blowers, or valve assemblies may be used to adjust the pressure in the anode portion 42. Oxygen ions from the cathode input stream 34 cross over the electrolyte and bond to hydrogen ions at the anode to form water molecules. Electrons produced in the oxidation reaction travel through an external circuit to generate electricity. Water formed at the anode, as well as unreacted hydrogen, exits the anode portion 42 via the anode exhaust stream 52. Unreacted oxidant gas exits the cathode portion 44 via the cathode exhaust stream 54.

When the pressure of the anode portion 42 exceeds that of the cathode portion 44, hydrogen gas molecules can pass through the electrolytes of the fuel cells from the anode to the cathode. The hydrogen molecules may react with oxygen in the cathode to form water (e.g., steam). The fuel cell system 10 includes a water concentration sensor 64 (e.g., a dew point sensor, a humidity sensor, etc.) positioned in the cathode exhaust stream 54. The water concentration sensor 64 is configured to measure the concentration of water in the cathode exhaust stream 54. The concentration of water in the cathode exhaust stream 54 can be used to detect changes in the amount (quantity, percentage, etc.) of the hydrogen molecules in the anode input stream 32 that are crossing over the electrolyte. An increase in the concentration of water detected in the cathode exhaust stream 54 by the water concentration sensor 64 indicates an increase in the number of hydrogen molecules crossing over the electrolyte, which indicates an increase in the relative pressure of the anode portion 42 compared to the cathode portion 44. In some embodiments, the air supplied in the cathode input stream 34 contains little to no water. Thus, any water detected in the cathode exhaust stream 54 will likely be due to hydrogen crossover. In some embodiments, the cathode input stream 34 may comprise a certain concentration of steam. The water concentration detected by the sensor 64 may be compared to the concentration of steam in the cathode input stream 34 to determine how much of the water in the cathode exhaust stream 54 is due to hydrogen crossover. The concentration of steam in the cathode input stream 34 may be measured, for example, by an additional water concentration sensor 65.

When the pressure of the cathode portion 44 exceeds that of the anode portion 42, oxidant gas molecules can pass through the electrolytes of the fuel cells from the cathode to the anode. The oxidant gas molecules exiting the anode portion 42 via the anode exhaust stream 52 dilute the steam and unreacted hydrogen in the anode exhaust stream 52. The fuel cell system 10 includes a hydrogen concentration sensor 62 positioned in the anode exhaust stream 52. The hydrogen concentration sensor 62 is configured to measure the concentration of hydrogen in the anode exhaust stream 52. The concentration of hydrogen in the anode exhaust stream 52 can be used to detect changes in the amount (quantity, percentage, etc.) of oxidant molecules in the cathode input stream 34 that are crossing over the electrolyte to the anode portion 42. A decrease in the concentration of hydrogen detected in the anode exhaust stream 52 by the hydrogen concentration sensor 62 indicates an increase in the number of oxidant molecules crossing over the electrolyte, which indicates an increase in the relative pressure of the cathode portion 44 compared to the anode portion 42. When the anode input stream 32 comprises fuel gas other than pure hydrogen, for example, a mixture of hydrogen and methane, or when there are minor impurities in the hydrogen stream, hydrogen concentration sensor data may be compared to the concentration of hydrogen in the anode input stream 32. The concentration of hydrogen in the anode input stream 32 may be measured, for example, by an additional hydrogen concentration sensor 63. In some embodiments, the amount of oxidant crossover can be determined by condensing and removing water formed in the fuel cell reactions from the anode exhaust stream 52 before measuring the hydrogen concentration using the hydrogen concentration sensor 62. The volumetric flow rate and hydrogen concentration in the anode input stream 32 can then be compared to the volumetric flow rate and hydrogen concentration of the dried anode exhaust gas, and the amount of oxidant that crossed over to the anode and further diluted the hydrogen can thereby be determined.

The hydrogen concentration sensor 62 and the water concentration sensor 64 are communicatively coupled to a controller 70. The controller 70 is configured to receive hydrogen concentration sensor data from the hydrogen concentration sensor 62 and water concentration sensor data from the water concentration sensor 64. The controller 70 is configured to determine, based at least in part on the hydrogen concentration sensor data and/or the water concentration sensor data, the differential pressure in the fuel cell module 40. In some embodiments, the system 10 may include only the hydrogen concentration sensor 62 without the water concentration sensor 64. In other embodiments, the system 10 may include only the water concentration sensor 64 without the hydrogen concentration sensor 62. In still other embodiments, the system 10 may include both the water concentration sensor 64 and the hydrogen concentration sensor 62. The fuel cell system 10 may also include pressure transducers 72 configured to respectively measure the pressure of oxidant entering the cathode portion 44 from the oxidant gas supply 14 and the pressure of fuel entering the anode portion 42 from the fuel supply 10, thus indirectly measuring the pressures in the cathode portion 44 and the anode portion 42. In some embodiments, the pressure transducers 72 may be directly coupled to the fuel cell module 40 and may directly measure the pressure in the cathode portion 44 and the anode portion 42. The controller 70 may use pressure measurements from the pressure transducers 72 along with the hydrogen concentration data and/or water concentration data to determine the differential pressure in fuel cell module 40. For example, the pressure measurements from the pressure transducers 72 may be used to establish a baseline differential pressure between the anode portion 42 and the cathode portion 44. Because the pressures of the gases entering the anode portion 42 and cathode portion 44 may differ from the pressures of the gases inside the anode portion 42 and cathode portion 44, the measurements from the pressure transducers 72 may not provide the most accurate pressure information to minimize crossover. The hydrogen concentration data and/or water concentration data may be used to adjust and improve the calculation of differential pressure.

In a system that includes only a hydrogen concentration sensor 62 and does not include a water concentration sensor 64, the controller 70 is configured to determine changes in the differential pressure between the anode portion 42 and the cathode portion 44 using the hydrogen concentration sensor data. For example, if the hydrogen concentration sensor data indicates a decrease in the hydrogen concentration in the anode exhaust stream 52, the controller 70 may determine that the pressure in the cathode portion 44 has increased relative to the pressure in the anode portion 42. As discussed above, this may indicate that oxidant gas from the cathode input stream 34 is crossing over the electrolytes in the fuel cells to the anodes and diluting the unreacted hydrogen in the anode exhaust stream 52. If the hydrogen concentration sensor data indicates an increase in the hydrogen concentration in the anode exhaust stream 52, the controller 70 may determine that the pressure in the cathode portion 44 has decreased relative to the pressure in the anode portion 42. This may indicate that less oxidant gas or no oxidant gas is crossing over the electrolytes of the fuel cells to the anode portion 42. It may also indicate that hydrogen is crossing over the electrolyte to the cathode portion 44.

In a system that includes only a water concentration sensor 64 and does not include a hydrogen concentration sensor 62, the controller 70 is configured to determine the differential pressure between the anode portion 42 and the cathode portion 44 using the water concentration sensor data. For example, if the water concentration sensor data indicates an increase in the concentration of water in the cathode exhaust stream 54, the controller 70 may determine that the pressure in the anode portion 42 has increased relative to the pressure in the cathode portion 44. As discussed above, this may indicate that more hydrogen from the anode input stream 32 is crossing over the electrolytes in the fuel cells to the cathodes and bonding with oxygen from the cathode input stream 34 to form water. If the water concentration sensor data indicates a decrease in the concentration of water in the cathode exhaust stream 54, the controller 70 may determine that the pressure in the anode portion 42 has decreased relative to the pressure in the cathode portion 44. This may indicate that less hydrogen or no hydrogen is crossing over the electrolytes of the fuel cells to the cathode portion 44. It may also indicate that oxidant gas is crossing over the electrolyte to the anode portion 42.

In systems that include both a water concentration sensor 64 and a hydrogen concentration sensor 62, the controller 70 is configured to determine the differential pressure between the anode portion 42 and the cathode portion 44 using both the hydrogen concentration sensor data and the water concentration sensor data. For example, if the water concentration sensor data indicates an increase in the concentration of water in the cathode exhaust stream 54 and the hydrogen concentration sensor data indicates an increase in the concentration of hydrogen in the anode exhaust stream 52, the controller 70 may determine that the pressure in the anode portion 42 has increased relative to the pressure in the cathode portion 44. If the water concentration sensor data indicates a decrease in the concentration of water in the cathode exhaust stream 54 and the hydrogen concentration sensor data indicates a decrease in the concentration of hydrogen in the anode exhaust stream 52, the controller 70 may determine that the pressure in the anode portion 42 has decreased relative to the pressure in the cathode portion 44.

When the controller 70 determines that the differential pressure between the anode portion 42 and the cathode portion 44 exceeds a predetermined value, the controller 70 is configured to adjust the pressure of fuel gas in the anode input stream 32 and/or the pressure of the oxidant gas in the cathode input stream 34 from the oxidant gas supply 14. The controller 70 is configured to send signals instructing the gas back-pressure regulators 22, 24 to adjust the respective pressures of the fuel gas in the anode input stream 32 and/or the oxidant gas in the cathode input stream 34 by, for example, increasing or decreasing the spring force sealing the respective valve. For example, if the controller 70 determines that the pressure in the anode portion 42 is too low relative to the pressure in the cathode portion 44, the controller 70 may instruct the fuel gas back-pressure regulator 22 to increase the spring force sealing the valve to increase the fuel gas pressure in the anode portion 42. Additionally or alternatively, the controller 70 may instruct the oxidant gas back-pressure regulator 24 to decrease the spring force sealing the valve to decrease the pressure of oxidant gas in the cathode portion 44. If the controller 70 determines that the pressure in the anode portion 42 is too high relative to the pressure in the cathode portion 44, the controller 70 may instruct the fuel gas back-pressure regulator 22 to decrease the spring force sealing the valve to decrease the fuel gas pressure in the anode portion 42. Additionally or alternatively, the controller 70 may instruct the oxidant gas back-pressure regulator 24 to increase the spring force sealing the valve to increase the pressure of oxidant gas in the cathode portion 44. Advantageously, the fuel cell system 10 allows continuous monitoring of hydrogen concentration in the anode exhaust stream 52 and water in the cathode exhaust stream 54, as well as real-time back-pressure regulator 22, 24 adjustments to balance pressure and minimize crossover. This can increase fuel gas utilization and minimize stresses in the fuel cells.

It should be understood that some amount of crossover is possible even when the pressures of the anode portion 42 and the cathode portion 44 are balanced, and that the methods described herein may be used to minimize crossover without eliminating crossover. In some embodiments, some pressure differential between the anode portion 42 and the cathode portion 44 may be desirable. In these embodiments, the water concentration data and hydrogen concentration data may be used by the controller 70 to achieve the desired differential pressure.

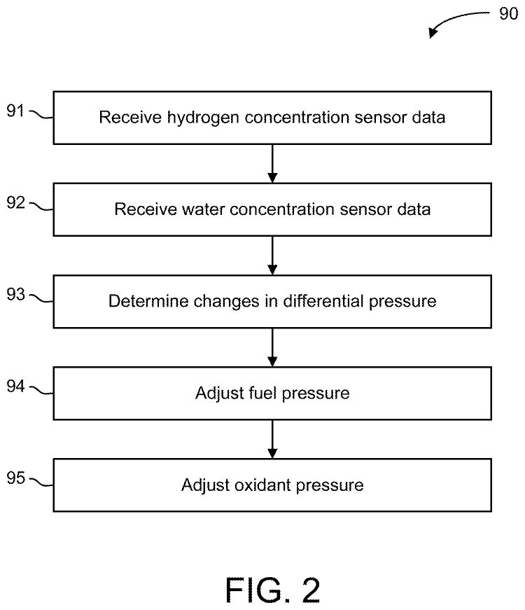

Referring to FIG. 2, a process 90 (e.g., a method) for controlling the pressures of reactant gases in a fuel cell system (e.g., fuel cell system 10) to achieve a desired pressure balance is shown. The process 90 may be performed, for example, by controller 70 in the fuel cell system 10. The process 90 begins at operation 91 with the receipt of hydrogen concentration data. The hydrogen concentration data includes the hydrogen concentration of the anode exhaust stream 52 of the fuel cell system 10, measured by the hydrogen concentration sensor 62. At operation 92, water concentration data is received. The water concentration data includes the water concentration of the cathode exhaust stream 54, measured by the water concentration sensor 64. At operation 93, changes in the differential pressure between the anode portion 42 and the cathode portion 44 are determined based on the hydrogen concentration data and the water concentration data. For example, as described above, a decrease in the hydrogen concentration of the anode exhaust stream 52 may indicate that the pressure in the cathode portion 44 has increased relative to the pressure in the anode portion 42. An increase in the water concentration of the cathode exhaust stream 54 may indicate that the pressure in the anode portion 42 has increased relative to the pressure in the cathode portion 44. Additional data may be used to determine changes in the differential pressure in addition to the hydrogen concentration data and the water concentration data. For example, direct pressure readings from pressure transducers 72 and gas concentration data from other sensors may be used to measure changes in the differential pressure.

Pressure transducers, however, may not provide a complete picture of the differential pressure in the fuel cell system 10 or the electrolysis cell system 110 (described below). As the chemical reactions occur in the fuel cells, ions are transported across the electrolytes and form gas molecules at the opposite electrode. Thus, the gas pressures in the anode portion 42 and the cathode portion 44 are often different proximate the gas inlets than proximate the outlets. There may be a point in the gas flow path, between the inlet and the outlet, at which crossover may be minimized by minimizing the differential pressure. However, the pressure transducers may be positioned outside the fuel cells themselves and not positioned precisely at that point. The pressure transducers may thus provide a baseline differential pressure, and fine pressure adjustments can be made based on the monitored crossover. For example, if the pressure transducers indicate that the pressure in the anode portion 42 is roughly equal to the pressure in the cathode portion 44, but the sensor data indicates that crossover from the anode portion 42 to the cathode portion 44 is still occurring, this may indicate that the pressure transducers are not positioned at the precise point at which crossover is minimized by minimizing the differential pressure.

The changes in differential pressure determined at operation 93 may be used to adjust the pressure of fuel gas and oxidant gas in the fuel cells. For example, it may be desired that the pressure in the anode portion 42 is equal to the pressure in the cathode portion 44. A baseline hydrogen concentration in the anode exhaust stream 52 and a baseline water concentration in the cathode exhaust stream 54 that correspond to equal pressure in the anode portion 42 and the cathode portion 44 may be determined. The water concentration data may be compared to the desired or baseline water concentration, and the hydrogen concentration data may be compared to the desired or baseline hydrogen concentration in order to determine how to adjust the pressures of fuel gas and oxidant gas. At operation 94, the pressure of fuel gas in the anode portion 42 is adjusted, and at operation 95, the pressure of oxidant gas in the cathode portion 44 is adjusted. For example, if it is determined at operation 93 that the hydrogen concentration in the anode exhaust stream 52 has decreased or is lower than a desired or baseline hydrogen concentration, which may indicate that the pressure in the anode portion 42 is too low relative to the pressure in the cathode portion 44, the fuel gas pressure may be increased and/or the oxidant gas pressure may be decreased until the desired or baseline concentrations are achieved. As discussed above, the pressures may be adjusted by controlling the valves of the back-pressure regulators 22, 24. If it is determined at operation 93 that the water concentration in the cathode exhaust stream 54 has increased or is higher than a desired or baseline concentration, which may indicate that the pressure in the anode portion 42 is too high relative to the pressure in the cathode portion 44, the fuel gas pressure may be decreased and/or the oxidant gas pressure may be increased until the desired or baseline concentrations are achieved. The desired or baseline concentrations of water and hydrogen may each be a range of concentrations with a predetermined upper threshold concentration and a predetermined lower threshold concentration. The gas pressures can be adjusted when one or both of the hydrogen concentration or water concentration exceeds the predetermined upper threshold or falls below the predetermined lower threshold.

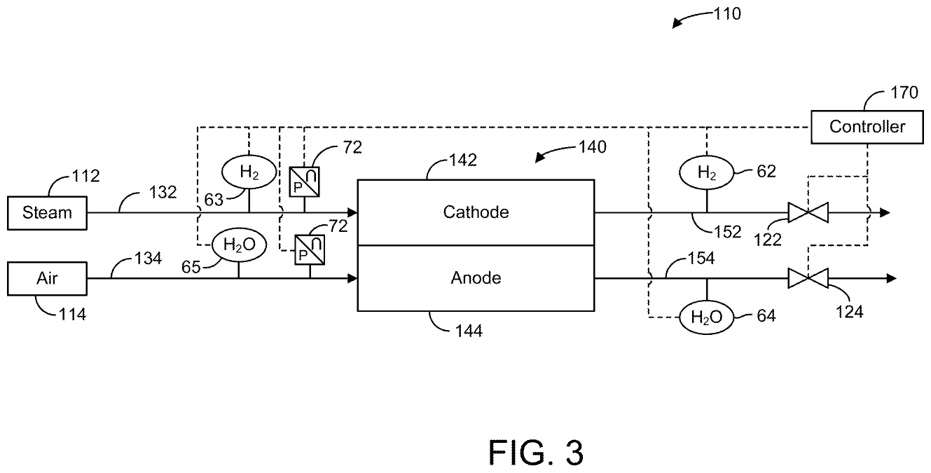

Referring now to FIG. 3, an electrolysis cell system 110 is shown in accordance with an exemplary embodiment. The electrolysis cell system 110 includes an electrolysis cell module 140. The electrolysis cell module 140 may be the fuel cell module 40 of fuel cell system 10 run in electrolysis mode. The anode of each fuel cell acts as a cathode in electrolysis mode, while the cathode of each fuel cell acts as an anode. The electrolysis cell module 140 may be described as having one or more stacks of electrolysis cells or one or more stacks of fuel cells operated in electrolysis mode. In electrolysis mode, steam is provided via the steam supply 112 and the steam flow controller 122 to the cathode portion 142 via the cathode input stream 132. An electrical current is applied to the cells in the module 140, which electrolyzes the water molecules. The electrical current causes oxygen ions from the steam to cross the electrolytes from the cathodes to the anodes and exit the anodes as oxygen gas, while hydrogen in the steam does not cross the electrolyte and instead exits the cathodes as hydrogen gas. Air from an air supply 114 is provided to the anode portion 144 of the electrolysis cell via the air flow controller 124 and the anode input stream 134 to dilute the oxygen gas in the anode exhaust stream 154 and to balance the pressure in the electrolysis cell module 140.

When the pressure of the anode portion 144 increases relative to the pressure in the cathode portion 142, the amount of nitrogen gas and other gases in the air crossing over the electrolytes increases, diluting the hydrogen in the cathode exhaust stream 152. When the pressure of the cathode portion 142 increases relative to the pressure in the anode portion 144, water molecules may cross over the electrolytes of the cells from the cathodes to the anodes. The hydrogen concentration sensor 62 is configured to measure the hydrogen concentration of the cathode exhaust stream 152 and the water concentration sensor 64 is configured to detect the concentration of water in the anode exhaust stream 154. Thus, the pressures of steam and air input into the electrolysis cell module 140 can be controlled similarly to the pressures of fuel gas and oxidant gas in the fuel cell module 40. The hydrogen concentration sensor 62 and the water concentration sensor 64 each send data to the controller 170. The controller 170 determines, based on the received data, changes in differential pressure between the cathode portion 142 and anode portion 144 and instructs the flow controllers 122, 124 to adjust the input pressures from the steam supply 112 and/or the air supply 114. The electrolysis cell system 110 may also include pressure transducers 72 respectively configured to measure the pressure of the steam entering the cathode portion 142 and the pressure of air entering the anode portion 144. In some embodiments, the electrolysis system may include an additional hydrogen concentration sensor 63 configured to measure the hydrogen concentration in the cathode input stream 132 and/or an additional water concentration sensor 65 configured to measure the water concentration in the anode input stream 134. The measurements can be compared to the measurements from the hydrogen concentration sensor 62 and the water concentration sensor 64 to determine how much crossover is occurring. As discussed above with respect to the fuel cell system 10, measurements from the sensors 62, 64 may provide a more accurate measurement of differential pressure than the pressure transducers 72 alone.

When the hydrogen concentration sensor 62 detects a decrease in the concentration of hydrogen in the cathode exhaust stream 152, indicating an increase in pressure of the anode portion 144 relative to the cathode portion 142, the controller 170 may instruct the steam flow controller 122 to increase the flow of steam from the steam supply 112 to the cathode input stream 132 and/or may instruct the air flow controller 124 to decrease the flow of air from the air supply 114 to the anode input stream 134. When the water concentration sensor 64 detects an increase in the concentration of water in the anode exhaust stream 154, indicating an increase in the pressure of the cathode portion 142 relative to the anode portion 144, the controller 170 may instruct the steam flow controller 122 to decrease the flow of steam from the steam supply 112 to the cathode input stream 132 and/or may instruct the air flow controller 124 to increase the flow of air from the air supply 114 to the anode input stream 134. Like in the fuel cell system 10 described above, the electrolysis cell system 110 may include one or both of the hydrogen concentration sensor 62 or the water concentration sensor 64, and the controller 170 may receive and use data from one or both of the sensors 62, 64. The electrolysis cell system 110 allows continuous monitoring of the hydrogen concentration in the cathode exhaust stream 152 and the water concentration in the anode exhaust stream 154 and real-time reactant flow adjustments to balance pressure and minimize crossover. This can increase hydrogen production and purity and can minimize stresses in the electrolysis cells.

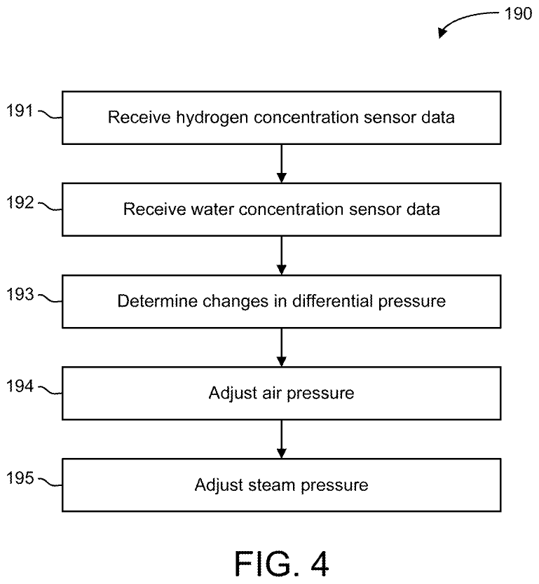

Referring to FIG. 4, a process 190 (e.g., a method) for controlling the pressures of reactant gases in an electrolysis cell system (e.g., electrolysis cell system 110) to achieve a desired pressure balance is shown. The process 190 may be performed, for example, by controller 170 in the electrolysis cell system 110. The process 190 begins at operation 191 with the receipt of hydrogen concentration data. The hydrogen concentration data includes the hydrogen concentration of the cathode exhaust stream 152 of the electrolysis cell system 110, measured by the hydrogen concentration sensor 62. At operation 192, water concentration data is received. The water concentration data includes the water concentration of the anode exhaust stream 154, measured by the water concentration sensor 64. At operation 193, changes in differential pressure between the cathode portion 142 and the anode portion 144 are determined based on the hydrogen concentration data and the water concentration data. For example, as described above, a decrease in the hydrogen concentration of the cathode exhaust stream 152 may indicate that the anode portion 144 has increased relative to the pressure in the cathode portion 142. An increase in the water concentration of the anode exhaust stream 154 may indicate that the pressure in the cathode portion 142 has increased relative to the pressure in the anode portion 144. Additional data may be used to determine changes in the differential pressure in addition to the hydrogen concentration data and the water concentration data. For example, direct pressure readings from pressure transducers and gas concentration data from other sensors may be used to determine changes in the differential pressure.

The changes in differential pressure determined at operation 193 may be used to adjust the pressures of steam and air to the electrolysis cells. For example, it may be desired that the pressure in the anode portion 144 is equal to the pressure in the cathode portion 142. A baseline hydrogen concentration in the cathode exhaust stream 152 and a baseline water concentration in the anode exhaust stream 154 that correspond to equal pressure in the cathode portion 142 and the anode portion 144 may be determined. The water concentration data may be compared to the desired or baseline water concentration, and the hydrogen concentration data may be compared to the desired or baseline hydrogen concentration in order to determine how to adjust the pressures of steam and air. At operation 194, the air pressure in the anode portion 144 is adjusted, and at operation 195, the steam pressure in the cathode portion 142 is adjusted. For example, if it is determined at operation 193 that the water concentration in the anode exhaust stream 154 has decreased or is lower than a desired or baseline water concentration, which may indicate that the pressure in the anode portion 144 is too low relative to the pressure in the cathode portion 142, the air pressure may be increased and/or the steam pressure may be decreased until the desired or baseline concentrations are achieved. If it is determined at operation 193 that the hydrogen concentration in the cathode exhaust stream 152 has decreased or is lower than a desired or baseline concentration, which may indicate that the pressure in the anode portion 144 is too high relative to the pressure in the cathode portion 142, the air pressure may be decreased and/or the steam pressure may be increased until the desired differential pressure is achieved. The desired or baseline concentrations of water and hydrogen may each be a range of concentrations with a predetermined upper threshold concentration and a predetermined lower threshold concentration. The gas pressures can be adjusted when one or both of the hydrogen concentration or water concentration exceeds the predetermined upper threshold or falls below the predetermined lower threshold.

### Configuration of Exemplary Embodiments

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. In some embodiments, methods may include additional steps or may omit recited steps. Also, two or more steps may be performed concurrently or with partial concurrence, unless specified differently above.

What is claimed is:

1. An electrolysis cell system comprising:
a cathode portion configured to output a cathode exhaust stream;
an anode portion configured to output an anode exhaust stream;
a sensor configured to detect a concentration in an exhaust stream and to output sensor data, wherein the sensor is either a hydrogen concentration sensor configured to detect a hydrogen concentration in the cathode exhaust stream or a water concentration sensor configured to detect a water concentration of the anode exhaust stream; and
a controller configured to:
receive the sensor data from the sensor; and
based on the sensor data, control at least one of (a) an air pressure adjustment device to adjust a pressure of air entering the anode portion or (b) a steam pressure adjustment device to adjust a pressure of steam entering the cathode portion.

2. The electrolysis cell system of claim 1, further comprising a first pressure transducer configured to measure anode gas pressure in the anode portion and a second pressure transducer configured to measure cathode gas pressure in the cathode portion, wherein at least one of the air pressure adjustment device or the steam pressure adjustment device is controlled in part based on a comparison between the measured anode gas pressure and the measured cathode gas pressure.

3. The electrolysis system of claim 2, wherein the controller is further configured to determine a differential pressure between the cathode portion and the anode portion based on the comparison between the measured anode gas pressure and the measured cathode gas pressure and the sensor data.

4. The electrolysis cell system of claim 1, wherein the air pressure adjustment device is a back-pressure regulator configured to allow the anode exhaust stream to flow therethrough and the steam pressure adjustment device is a back-pressure regulator configured to allow the cathode exhaust stream to flow therethrough.

5. The electrolysis cell system of claim 1, wherein the sensor is a hydrogen concentration sensor and the controller is configured to at least one of (a) control the steam pressure adjustment device to increase the pressure of steam entering the cathode portion when the sensor data indicates a decrease in the hydrogen concentration of the cathode exhaust steam or (b) control the air pressure adjustment device to decrease the pressure of air entering the anode portion when the sensor data indicates a decrease in the hydrogen concentration of cathode exhaust stream.

6. The electrolysis cell system of claim 1, wherein the sensor is a water concentration sensor and the controller is configured to at least one of (a) control the steam pressure adjustment device to decrease the pressure of steam entering the cathode portion when the sensor data indicates an increase in the water concentration of anode exhaust stream or (b) control the air pressure adjustment device to increase the pressure of air entering the anode portion when the sensor data indicates an increase in the water concentration of anode exhaust stream.

7. An electrolysis cell system comprising:
a cathode portion configured to output a cathode exhaust stream;
an anode portion configured to output an anode exhaust stream;
a first hydrogen concentration sensor configured to detect a hydrogen concentration in the cathode exhaust stream; and
a controller configured to:
receive first hydrogen concentration sensor data from the first hydrogen concentration sensor; and
based on the first hydrogen concentration sensor data, control at least one of (a) an air pressure adjustment device to adjust a pressure of air entering the anode portion or (b) a steam pressure adjustment device to adjust a pressure of steam entering the cathode portion.

8. The electrolysis cell system of claim 7, wherein the controller is configured to, when the first hydrogen concentration sensor data indicates that the hydrogen concentration in the cathode exhaust stream has decreased below a predetermined threshold, control at least one of (a) the steam pressure adjustment device to increase the pressure of steam entering the cathode portion or (b) the air pressure adjustment device to decrease the pressure of air entering the anode portion.

9. The electrolysis cell system of claim 7, further comprising a second hydrogen concentration sensor configured to detect a hydrogen concentration of a cathode input stream, the cathode portion configured to receive the cathode input stream, wherein the controller is further configured to:
receive second hydrogen concentration sensor data from the second hydrogen concentration sensor;
compare the first hydrogen concentration sensor data to the second hydrogen concentration sensor data; and
control at least one of the air pressure adjustment device or the steam pressure adjustment device based on the comparison.

10. The electrolysis cell system of claim 1, further comprising a first pressure transducer configured to measure anode gas pressure in the anode portion and a second pressure transducer configured to measure cathode gas pressure in the cathode portion, wherein at least one of the air pressure adjustment device or the steam pressure adjustment device is controlled in part based on a comparison between the measured anode gas pressure and the measured cathode gas pressure.

11. The electrolysis cell system of claim 1, further comprising a first water concentration sensor configured to detect a water concentration of the anode exhaust stream, wherein the controller is configured to:
receive first water concentration sensor data from the first water concentration sensor; and
based on both the first water concentration sensor data and the first hydrogen concentration sensor data, control at least one of (a) the air pressure adjustment device to adjust the pressure of air entering the anode portion or (b) the steam pressure adjustment device to adjust the pressure of steam entering the cathode.

12. The electrolysis cell system of claim 11, wherein the controller is configured to, when the water concentration sensor data indicates that the water concentration in the anode exhaust stream has increased beyond a predetermined threshold, control at least one of (a) the air pressure adjustment device to increase the pressure of air entering the anode portion or (b) the steam pressure adjustment device to decrease the pressure of steam entering the cathode portion.

13. The electrolysis cell system of claim 11, further comprising:
a second hydrogen concentration sensor configured to detect a hydrogen concentration of a cathode input stream; and
a second water concentration sensor configured to detect a water concentration of an anode input stream, the cathode portion configured to receive the cathode input stream.

14. The electrolysis cell system of claim 13, wherein the controller is further configured to:
receive second hydrogen concentration sensor data from the second hydrogen concentration sensor;
receive second water concentration sensor data from the second water concentration sensor;
perform a first comparison between the first hydrogen concentration sensor data and the second hydrogen concentration sensor data;
perform a second comparison between the first water concentration sensor data and the second water concentration sensor data; and
control at least one of the air pressure adjustment device or the steam pressure adjustment device based on the first comparison and the second comparison.

15. The electrolysis cell system of claim 7, wherein the air pressure adjustment device is a back-pressure regulator configured to allow the anode exhaust stream to flow therethrough and the steam pressure adjustment device is a back-pressure regulator configured to allow the cathode exhaust stream to flow therethrough.

16. An electrolysis cell system comprising:
a cathode portion configured to output a cathode exhaust stream;
an anode portion configured to output an anode exhaust stream;
a first water concentration sensor configured to detect a water concentration of the anode exhaust stream; and
a controller configured to:
receive first water concentration sensor data from the first water concentration sensor; and
based on the first water concentration sensor data, control at least one of (a) an air pressure adjustment device to adjust a pressure of air entering the anode portion or (b) a steam pressure adjustment device to adjust a pressure of steam entering the cathode portion.

17. The electrolysis cell system of claim 16, wherein the controller is configured to, when the first water concentration sensor data indicates that the water concentration of the anode exhaust stream has increased beyond a predetermined threshold, control at least one of (a) the steam pressure adjustment device to decrease the pressure of steam entering the cathode portion or (b) the air pressure adjustment device to increase the pressure of air entering the anode portion.

18. The electrolysis cell system of claim 16, further comprising a second water concentration sensor configured to detect a water concentration of an anode input stream, the anode portion configured to receive the anode input stream, wherein the controller is further configured to:
receive second water concentration sensor data from the second water concentration sensor;
compare the first water concentration sensor data to the second water concentration sensor data; and
control at least one of the air pressure adjustment device or the steam pressure adjustment device based on the comparison.

19. The electrolysis cell system of claim 16, further comprising a first pressure transducer configured to measure a pressure of anode gas in the anode portion and a second pressure transducer configured to measure a pressure of cathode gas in the cathode portion, wherein at least one of the air pressure adjustment device or the steam pressure adjustment device are controlled in part based on the measured anode gas pressure and the measured cathode gas pressure.

20. The electrolysis cell system of claim 16 wherein the air pressure adjustment device is a back-pressure regulator configured to allow the anode exhaust stream to flow therethrough and the steam pressure adjustment device is a back-pressure regulator configured to allow the cathode exhaust stream to flow therethrough.
